(19) United States
(12) Patent Application Publication
(10) Pub. No.: US 2012/0123861 A1
(43) Pub. Date: May 17, 2012

(54) ONLINE EDUCATIONAL PROGRAM AND INSTRUCTION PROCESS

(76) Inventor: Virginia Silverman, Laguna Niguel, CA (US)

(21) Appl. No.: 13/376,157

(22) PCT Filed: Jun. 7, 2010
(86) PCT No.: PCT/US10/37635

§ 371 Date: Feb. 1, 2012

Related U.S. Application Data
(60) Provisional application No. 61/184,442, filed on Jun. 5, 2009.

(51) Int. Cl. G09B 7/00; G06Q 30/02

(52) U.S. Cl. 705/14.49; 434/362

(57) ABSTRACT

An improved online medical education program that allows a user to access the site and input information into the system relating to their medical condition is provided. Once information has been inputted into the system, the individuals may be directed to an area which allows them to learn information relating to their specific medical condition. The system and program may deliver to an individual with a specific medical condition, comprehensive disease management programs that are centered on behavior modification and education about the disease and the long and short term impact on their lives. The education program may provide the user a day-by-day management program which lasts for a predetermined period of time.

### PRIORITY CLAIM

This application claims priority to the earlier filed U.S. Provisional Application No. 61/184,442 filed on Jun. 5, 2009.

### FIELD OF THE INVENTION

The field of the invention is for online therapeutic systems and programs. More specifically, the field of invention is for an online system and program for the education and management of diabetes.

### BACKGROUND

Social networking and online educational systems have become an important way for people to interact, share experiences and information with each other. Historically, social networking and educational programs were predicated on a geographical location and socio-economic status. Even with an outside socio-economic status, the interaction between individuals was predicated on specific interests and hobbies such as car enthusiasts or divorce support networks.

For example, a divorce support network would have a dedicated meeting place, such as a community center where divorcees could come together and discuss important issues or trials in their lives. The divorce support network meeting might have an open meeting once a week at a specific venue, meaning any person with divorce issues could come to the meetings, share experiences and problems with the group and get support from other group members. However, an inherent problem with these types of social networking groups is the frequency and timing of the meetings. For example, if the meeting occurred on a Wednesday evening and a person desired to go to the meeting, but had a conflict with another meeting or scheduled event, the individual may not be able to attend, and thus may not be able to get the support that the individual needs. Additionally, another problem with these types of network groups relate to an individual's need for support when it is convenient for that individual, or when the need is the greatest. For example, the once a week meeting may not be enough support for a specific individual. Additionally, the individual may go through times when they really need support on a Saturday, but would have to wait until the Wednesday meeting for support, or look for another support group that may have a meeting on Saturday.

With the advent of the internet, information and resources may be available to the public at any time. A person desiring information on any matter may simply perform an online search request and get responses to their query within a very short time period. However, the need for support and experience requires an online site that provides information and resources to these queries.

There are many online networking and educational sites that provide online factual information including numerous match-making sites that provide services to get individuals together for dating and mating purposes. There are online health sites that provide information about various health concerns and articles relating to health studies. There are even online sites that provide divorce resources, sporting resources and a plurality of other information and networking opportunities.

However, when it comes to health related online education and participation programs, the resources are much more limited because of our desire to keep medically related information private and because we desire individuals to discuss their medical conditions with a physician. Individuals that suffer from specific diseases and ailments may be able to get general information from internet websites, but there is a general lack of internet websites that are specifically set up for specific diseases and ailments which allow the individuals to discuss their problems, diagnosis, medical statistics and other information and at the same time go through a program which will help them to evaluate their understanding, knowledge and dealing with their diagnosis.

Therefore, a need exists for an improved online health educational system and program. More specifically, a need exists for an improved online health education system and program which may help individuals with specific medical problems have access to a program which may be specifically tailored to their medical conditions. Additionally, a need exists for an improved online medical/health educational system and a program which may show the progress of an individual with a particular medical condition from the initial diagnosis through living with that particular medical condition. The system may also receive information input by the patient, and give pertinent information to that individual relating to their ailments. Moreover, a need exists for an online medical educational program that can help manage and change behavior for chronic disease management.

### SUMMARY OF THE INVENTION

The present invention provides an improved online medical education program that allows a user to access the site and input information into the system relating to their medical condition. Once information has been inputted into the system, the individuals may be directed to an area which allows them to learn information relating to their medical condition. The system and program may deliver to an individual with a specific medical condition, comprehensive disease management programs that are centered on behavior modification, education about the disease and the long and short term impact on their lives. The education program may provide the user with a day-to-day management program which is available for a predetermined period of time.

Among the many different possibilities contemplated, the system facilitates an online forum for individuals desiring support and education of their diagnosis.

Additionally, in an exemplary embodiment, the system and program may be tailored to give day-to-day direction and management techniques.

Additionally, in an exemplary embodiment, the system and program may be utilized by an individual patient and/or user for management of a chronic disease.

In yet another exemplary embodiment, it is contemplated that the online medical educational system and program may address healthcare management needs for an individual.

In an exemplary embodiment, it is contemplated that the online medical education system and program may be utilized for a variety of different medical conditions.

In another exemplary embodiment, it is contemplated that the online medical education system and program may be utilized for the treatment and management of diabetes whether type 1 or type 2.

In still another exemplary embodiment, it is contemplated that the online medical education and management system and program may be provided, whereby the individual user may utilize the system to manage their chronic health condition.

A further exemplary embodiment contemplates that the online medical education system and program which may provide market research approach to fulfill the needs of the individual.

In yet another exemplary embodiment, the online medical education system and program whereby the system and program may include online access to medical experts, and medical forums.

Yet another exemplary embodiment is to provide an online medical education program whereby the needs of both the individual patient and corporations that may sponsor the system may be provided.

Additionally, in an exemplary embodiment, the online medical education program and system may provide a targeted interactive personal engagement form which evaluates the needs of the individual patient.

In yet another exemplary embodiment of the present invention the online medical education program and system may provide a targeted interactive personal engagement mechanism to determine progression of management and other issues input by the individual patient and/or end user.

Still another exemplary embodiment of the present invention is to provide an online medical education program and system that may identify eligible individuals and their needs to match them with information and support groups within the system that are relevant for their individual needs.

Yet another exemplary embodiment of the present invention is to provide an online medical education program and system which identifies specific individuals based on their input criterion and matches these specific individuals with relevant service providers including doctors, pharmacists and the like.

Still another exemplary embodiment is to provide an online medical education program and system which may utilize questionnaires and surveys to determine patient progression and management of their chronic disease.

In yet another exemplary embodiment of the present invention, the online medical education program and system may provide notifications, voicemails, text messages and e-mails that may keep the individual user focused and motivated, which in turn may lead to higher compliance with disease management.

Another exemplary embodiment of the invention is to provide an online medical education program and system which may utilize questionnaires, surveys, medical information and online activities to determine appropriate caregivers and medical support individuals.

In yet another exemplary embodiment, an online medical education program and system is provided wherein the system may allow individuals to lead healthier lives and properly manage their chronic disease.

A further exemplary embodiment is to provide an online medical education program and system whereby the system may track and identify individual users for clinical, qualitative and quantitative research.

Another exemplary embodiment is to provide an online medical education program and system whereby the system may identify and collect patient feedback on program management, educational content and articles.

In still another exemplary embodiment, an online medical education program and system may be provided whereby the system may allow users to interact with other individuals having similar treatment and diagnosis.

Another exemplary embodiment is to provide an online medical education program and system whereby the system may incentivize individual users to engage in online activities with a point reward system, certificate levels, and/or other virtual and non-virtual incentives.

Still another exemplary embodiment is to provide an online medical education program and system whereby the system may provide patients and caregivers with a mix of emotional and social support, relevant clinical information and incentives to improve the knowledge, understanding, comfort level with a particular disease and/or ailment and still provide industry feedback through the system.

Yet another exemplary embodiment is to provide an online medical education program and system whereby the system may provide real-time information to patients and caregivers which is outbound and may give a daily message or reminders for proper disease management techniques.

In yet another exemplary embodiment, an online medical education program and system may be provided whereby the individual users may track their progress with the use of the system and information relating to their progress and management may be displaced such as a daily action plan tracker, step tracker, results charts and graphs, hydration trackers, food trackers, medication trackers and the like.

In another exemplary embodiment, an online medical program and system may be provided whereby the system may incentivize consumer communication with industry through virtual and non-virtual compensation for participating in qualitative, quantitative and clinical research.

In another exemplary embodiment, an online medical education system, the system comprising: an online website having a plurality of sub-sites; an input criterion page whereby an end user inputs specific information into the criterion page; a remote central server having a database for collection of input criterion; a processing portion for analyzing and providing medically relevant information to the end user based on user input criterion; and a targeted interactive personal engagement portion.

In another exemplary embodiment, wherein said targeted interactive personal engagement portion provide instructions relating to specific chronic diseases.

In another exemplary embodiment, wherein said system provides educational information to end user for a chronic disease.

In another exemplary embodiment, wherein said chronic disease is diabetes.

In another exemplary embodiment, wherein said system provides a targeted educational steps and reminders to users.

In another exemplary embodiment, wherein said system provides an online social networking portion to allow users to interact with other users with the same chronic health condition.

In another exemplary embodiment, wherein said system utilizes questionnaires, surveys, medical files and other target information to allow the user to manage and illustrate progress of disease management.

In another exemplary embodiment, wherein the system provides direct marketing and advertising to an end user.

In another exemplary embodiment, wherein the system incentivizes users to engage in online activities with virtual and non-virtual incentives.

In another exemplary embodiment, wherein the system identifies patient candidates for clinical, qualitative and quantitative research.

In another exemplary embodiment, a method of providing online medical education, the method comprising the steps of: having a remote individual user computer to access an online website; providing a remote central server having a database for collection of input criterion; providing a processing portion for analyzing and providing medically relevant information to the end user based on user input criterion; and providing a feedback module to transmit medical information relating to care of a chronic medical condition to the individual user computer.

In yet another exemplary embodiment, further comprising the step of: providing educational information to end user for a chronic disease.

In another exemplary embodiment, further comprising the step of: providing research access from a remote location for inclusion of the most recent research information to the individual end user computer.

In another exemplary embodiment, further comprising the step of: providing an online social networking portion to allow users to interact with other users with the same chronic health condition.

In another exemplary embodiment, further comprising the step of: providing direct marketing and advertising to an end user.

Another exemplary embodiment is to provide an online medical program and system whereby the system may provide consumer access to advertisers, clinicians and researchers through the educational site.

In still another exemplary embodiment, an online medical program and system may be provided whereby the system may provide industry patient feedback to provide customized, relevant information and improve healthcare solutions of specific diseases, ailments and conditions.

Yet another exemplary embodiment is to provide an online medical program and system which may provide targeted interactive engagement and incentives to the end user which encourages patient management of their disease.

In another exemplary embodiment, an online medical program and system may be provided whereby the system may encourage interaction between individual user and healthcare to provide and increase monitoring of the disease without the need for costly medical treatment.

A further exemplary embodiment is to provide an online medical program and system whereby the system may provide the individual user with personal experiences, blogs, past treatment experiences, struggles, symptoms, co-existing conditions and desired characteristics for an individual patient, caregiver or end user.

In yet another exemplary embodiment, an online medical program and system may be provided whereby the system may provide outlines for relationships with support partners, management of diseases, coaching and support, networking opportunities and the ability for remote communication with individual patients and users.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 illustrates the online medical program and system in an exemplary embodiment of the present invention.

FIG. 2 illustrates a schematic of the online medical program and system in an exemplary embodiment of the present invention.

### DETAILED DESCRIPTION OF THE INVENTION

Referring now to the Figures, wherein similar elements of the instant invention are referenced in like manner, preferred methods and accompanying systems for online health consultation and education are provided.

It should be understood that an online medical consultation and education system may be described. In an exemplary embodiment, an online medical consultation and education system for the treatment and education of individuals with diabetes is described. However, it should be understood that the present invention may be utilized for any known chronic medical condition. A person of ordinary skill in the art would contemplate the use of the system for any know chronic medical condition which may benefit from the use of a consultation, educational and progressive, long term treatment option.

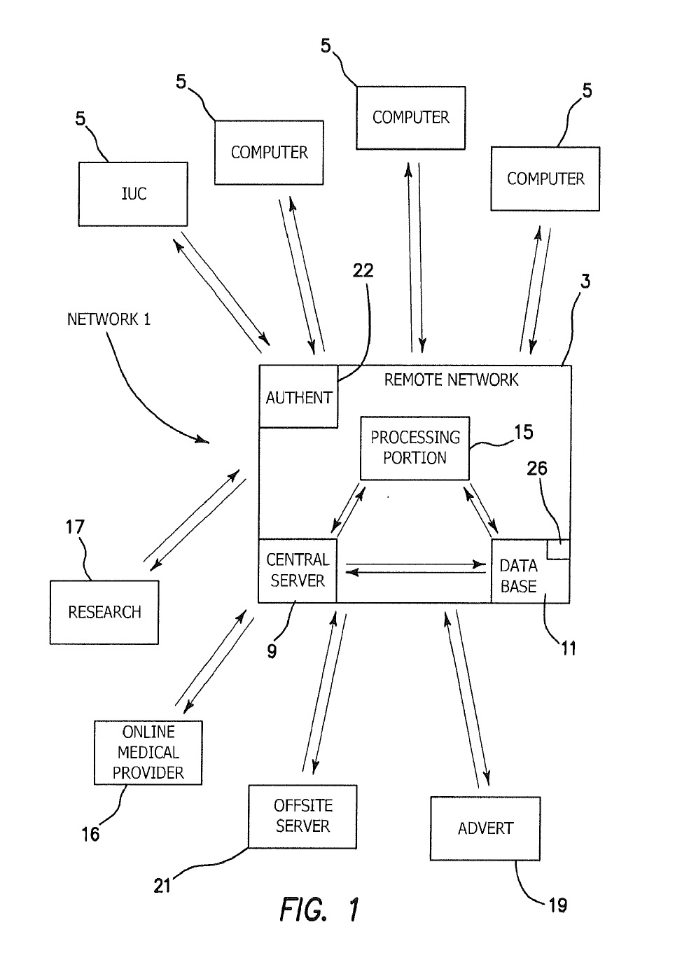

As illustrated in FIG. 1, the present invention illustrates a system and method for the treatment, education and consultation of a chronic medical condition, such as diabetes. The system allows an individual to utilize the online system to manage the chronic medical condition without the need for constant in-patient, in-person consultation with a trained medical provider in a medical setting. The present invention may have at least a network system 1 which is utilized to allow for online access to a medical support, treatment, and education site that may be utilized by an individual having a chronic medical condition. In an exemplary embodiment, the network system 1 allows for connectivity of a plurality of individual user computers 5 to the network system 1. It is contemplated that the network system have at least a remotely operated network 3 whereby the remotely operated network 3 has a central server 9 located thereon. The central server 9 acts as a host to the online medical site which is accessed by each of the individual user computers 5. The central server 9 also hosts all information input by each of the individual user computers 5 when accessing, and utilizing the system 1. It is also contemplated that the system may have at least a database 11 located within the central server 9 and a processing portion 15 also located within the central server 9. It is contemplated that each individual user computer 5 may have access to the central server 9 and may access information stored in the database 11. However, it is also contemplated that an online medical provider and/or counselor 16 may also access the system 1 utilizing the network 1 and may input information into the database 11 of the central server 9 whereby the information may be instructional information, educations information, general input, encouragement and other information which may be beneficial to the individual user computer 5 users for the maintenance and education of their chronic medical condition. The online medical provider and/or counselors 16 may be located at a remote location and may be provided with information input by the individual user computers 5 to specifically target and help promote long term care of that individual user utilizing the system 1.

It is further contemplated that they system 1 may have other computer peripheries connected thereto to help promote long term management of a chronic medical condition. Therefore, the system may provide an area specifically related to advertising by medical device/pharmaceutical companies and ongoing research information provided by scientists and research doing research in that particular chronic medical field. The system 1 may provide a separate portal for remote advertising access 19 and research access 17 into the system 1 and for the information input by the advertising access 19 and research access 17 to be stored in the database 11 for use and display to an of the plurality of individual user computers 5 that either desire the information, or have input enough information for the processing portion 15 to believe that the advertising and/or research information be provided to the particular individual user computer 5.

It should be understood that the system network 1 may include any type of connection operable to transmit data between the database 11, the central processing portion 15 and the individual computer user computers 5. Therefore, it is contemplated that the network 1 may be any of a local area network, a wide area network, an electronic bulletin board system, a telecommunications line, internet, and the like.

In an exemplary embodiment, it should be understood that the individual user computers 5 may be any computing device that would allow a user utilizing the individual user computer 5 to access the online medical system 1 to both transmit and receive information from the site. The individual user computer 5 may be any type of device, such as personal computers, laptops, PDA, smartphones and the like that allows the remote user to transmit information to the system 1 which is stored in the database 11 of the central server 9. Additionally, the system 1 allows information to be received from the central server 9 directly to the individual user computer 5 to help manage the chronic medical condition. The information received from the central server 9 may be educational, medical, or purely social to encourage behavior that will maintain a healthy outlook for the individual patient/user.

Typical communication between the individual user computers 5 and the central server 9 containing the database 11 and the processing portion 15 of the central server 9 may be through a dedicated offsite server 21. The offsite server 21 may direct the individual user computer 5 to the central server 9 for access to the online medical system 1. Only after the individual user computer 5 have accessed the central server 9 may they get access to the information stored in the database 11 and be provided with information determined by the processing portion 15 of the system. Further it is contemplated that at least an authentication portion 22 be provided to allow the individual user computer 5 access to the central server 9 and information may not be transmitted or received by the individual user computer 5 until the authentification portion 22 has been satisfied. The processing portion 15 of the central server 9 may also be able to utilize information input by the individual user computers 5 to determine which portion of the online medical site that particular user will be able to access and what stored information from the database 11 would be most pertinent to that individual user/patient. Again, it should be understood that the individual user computers 5 are preferably one or more remote personal computing systems such as laptops, personal computers, PDAs, smartphones and the like that are specifically designated by persons who wish to consult and receive online education of their particular medical conditions. Additionally, the system 1 may note specific IP (Internet protocol) addresses utilized by a particular patient and/or end user such that the system 1 may check authentification against the specific IP addresses to make sure that the user has access rights to the database 11 of the central server 9, thereby creating a failsafe against unauthorized access to private medical information input by the individual user computers 5. It is contemplated that this IP address check may be overridden by a secondary authentification system (not shown), if the individual user is not capable of utilizing their own computing system, or the patient, user is out of town and does not have access to their own individual user computer 5.

The system 1 also contemplates that an online health care provider 16 or counselor may be available to an individual user located at an individual user computer 5 and that the online health care provider/counselor 16 be available to the individual user as needed, or when the processing portion 15 deems an intervention necessary based on information input by the individual user. The online health care provider 16 or counselor may have one or more computing devices operative to receive data from database 11 of the central server 9, which in turn receives its information from the individual user computer 5. The processing portion 15 may then transmit information from the database 11 to the online health care providers 16 to allow the provider to monitor or intervene when the processing portion 15 has calculated that consult of a online health care provider 16 is necessary or beneficial for the user of the individual user computer 5. The processing portion 15 may utilize unique algorithms that are pre-input by the online health care providers 16 or even by the research access 17 that determines when a threshold has been hit and that the intervention of a online health care provider 16 may be necessary to promote education, or maintenance of the particular user's long term care of their chronic medical condition. In an exemplary embodiment of the present invention, an individual user may submit their personal and medical information as well as submit particular problems, concerns or feelings to the online health care provider 16 and/or counselor to receive information, counseling and/or education on how to deal with particular concerns to that individual user having a medical condition. The online health care provider 16 and/or counselor may cause information input from the individual user computer 5 to be stored in the database 11 of the central server 9 for later use and for monitoring of the individual user's long term medical care and education and treatment.

Further, FIG. 1 illustrates that the advertising access 19, research access 17 and educational information 26 may be stored in the database 11 and provided to the individual user computers 5 when sufficient information is received from the individual user computer 5 to warrant specific advertising and/or educational information to be transmitted from the database 11 and processing portion 15 to the individual user computer 5. It is further contemplated that educational access, research access 17 and medical portions may be connected to the network 1 via the central server 9 such that information may be retrieved from the database 11 to evaluate medical conditions over a period of time. It is contemplated that an online medical provider 16 and/or counselor may access the health information input by the individual user (via the individual user computer 5) to monitor the health and overall medical condition of any individual user. Moreover, the online medical provider 16 and/or counselor may utilize information to educate the user and/or provide instruction and support for the medical condition faced by the individual user. It is contemplated that information stored in the database 11 may also be utilized to determine further health risks for an individual patient over a period of time. Thus, access to collected information may be provided to the online medical provider 16 and/or counselor as well as others not specifically mentioned. Access to the information may be provided either for free or for a fee. Access may furthermore be provided on a subscriber basis or on a transaction-by-transaction basis. In addition, access to individual records may be provided to these and other entities while maintaining the anonymity of the individual submitting the information and/or suppressing any other submitted information as desired.

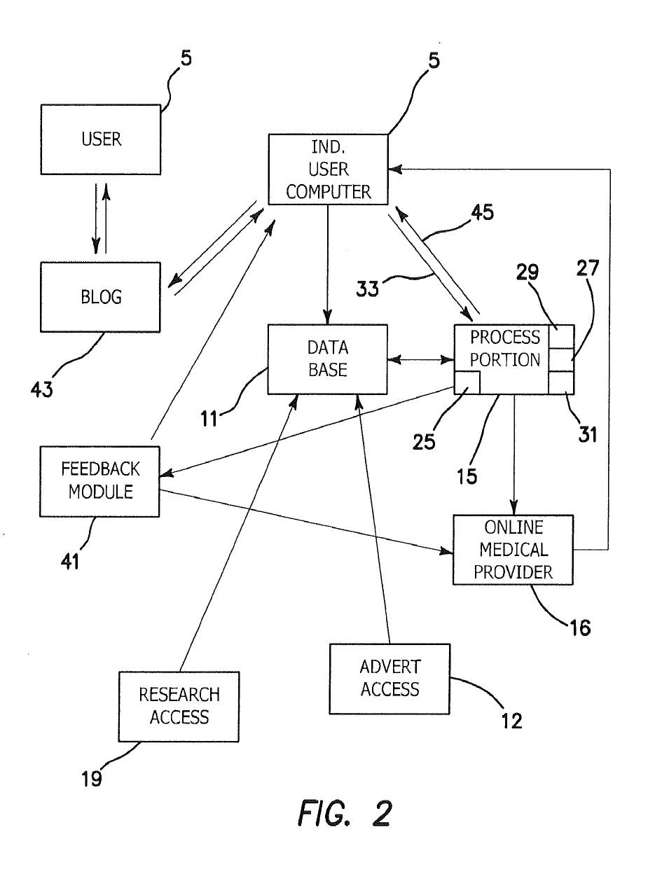

Referring now to FIG. 2, the data received from the individual user computer 5, in an exemplary embodiment may be stored in a database 11 which is accessed through a processing portion 15. The processing portion 15 may receive information input from the individual user computer 5 and have pre-installed algorithms that allows the processing portion 15 to receive information from the individual user computer 5 and analyze and interpret the information for transmitting specific information either back to the individual user computer 5 and/or to a online medical provider/counselor 16 to interact with the specific user. The processing portion 15 is fully capable of being operative to instructions and inputs received from any of the individual user computers 5, online medical providers/counselors 16, research access 19 and advertising access 17, in accordance with the present invention. The processing portion 15 may also have at least a processor 25 which may be any commonly available microprocessor and may also have RAM/ROM 27, clock 29, data storage device 31 which may store online data, and the entirety of the online system 1. The system 1 may also include a plurality of input devices 33 and output devices 35. It is contemplated that the RAM/ROM 27 may have at least the storage capacity to hold the online website for access by each individual user computer 5. Moreover, the RAM/ROM 27 may have sufficient storage space to store and transfer processing instructions utilized by processing portion 15 and receive additional information from any of the accessing portions of the system. The read-only memory (ROM) portion of RAM/ROM 27 may be any permanent non-re-writable memory medium capable of storing and transferring, inter alia, processing instructions performed by processor during a start-up routine of central processing portion. Further functions of RAM/ROM 27 will be apparent to one of ordinary skill in the art.

The database 11 may be either of an internal or external memory unit. It is contemplated that the database 11 is sufficiently large to store all information input by the individual user computers 5 and all information received from advertising access 17 and research access 19 along with information provided by the online medical provider/counselor 16. The database 11 may include any of necessary hardware to store information, including, but not limited to: a floppy disk drive, a hard disk drive, a CD-ROM disk and reader/writer, a DVD disk and reader/writer, and/or any other computer readable medium that may be encoded with processing instructions in a read-only or read-write format.

In still another exemplary embodiment, the online medical system 1 may have a patient feedback module 41 to provide customized, relevant information and improve healthcare solutions of specific disease, ailments and conditions back to the individual user computer 5. For example, it is contemplated that the system 1 may have a feedback module 41 which will provide targeted interactive engagement and incentives to the end user located at the individual user computer 5 which encourages patient management of their disease and may notify the online medical provider 16 and/or counselor of the progress of each individual patient. The system 1 encourages interaction between the individual user and the online healthcare provider 16 and/or counselor to provide and increased monitoring of the disease without the need for costly medical treatment.

The system further includes at least a blog option 43 which allows the individual user computer 5 to have input from a user which provides personal experiences, blogs, past treatment experiences, struggles and symptoms, co-existing conditions and desired characteristics for an individual patient, caregiver or end user. The option will allow a plurality of users to read and see other individuals having similar problems and conditions and interact such that they can review and utilize feedback and potential treatment options without needing to seek out medical treatment from a treatment facility.

It is further contemplated that the system 1 may have a plurality of input devices 43 that may communicate information to the processing portion 15 via either another computer system or by user inputs. Accordingly, input devices may include a keyboard, a mouse, a graphics tablet, a scanner, a voice recognition unit, a parallel or serial communication port, a modem, a network connection and any appropriate network or other communication card for receiving data. Input devices allow a user to input information into the system 1 via the central server 9 whereby they are stored in the database 11. Output devices 45 may also be provided whereby the output devices 45 are utilized by the processing portion 15 to communicate with the individual computer user 5. Output devices 45 may be any device which allows the central server 9 to communicate with the individual user computer 5 and to “push” data from the database 11 to the individual user computer 5.

In an exemplary embodiment, it is contemplated that the system utilizes a proprietary software system to allow individual end users to access an online forum whereby the system utilizes a program which may include a plurality of processing instructions which enables the processing portion 15 to receive information from the individual user, process, analyze and determine what access each individual user should be given. The proprietary software may be written in any conventional computer language and may be upgraded with research access 19 as needed to treat and management a chronic medical condition.

Each individual patient located at an individual user computer 5 may input a variety of information relating to their medical needs. The health status of the user may then be determined according to a number of factors pre-determined by the proprietary software to determine what medical needs are required or requested by each individual user. Many different factors may be utilized to determine the user's access to the system 1. Factors such as a person's age, weight, activity level, ethnic background, medical history, progression of the chronic medical condition, personal struggles, family medical conditions, and other social issues related to the medical condition may all be utilized to determine access and provide educational information, guidance and management of the chronic medical condition as desired by the present invention.

The health status, once determined, may then be used to diagnose a medical condition of the user and to determine any necessary course of treatment, including prescribing further tests or providing relevant medical information, counseling, education and other tools to be utilized by the individual user located at a remote location. In addition, as each user submits their information and health statistics, the system more accurately describe the health condition of the population at large and may provide researchers, insurance providers, consultation, education and the like. Moreover, the system may also provide access to other users having identical medical problems to allow for therapeutic interaction between individual patients with like medical problems. The interaction between a plurality of individual patients may also allow individuals to determine therapies and treatment options that have worked for any individual patient which may be found to be beneficial for other individual patients in the management and care of their chronic medical condition.

Additionally, the database 11 of the system 1 may have a plurality of different fields utilized to use the system 1. For example, the processing portion 15 may have at least an authentification system which includes a password field, and IP address field, and access for an online medical provider/cousellor, medical history input and others with chronic disease field. The plurality of fields may be utilized to store information relating to any of the named fields including progress to any specific chronic medical condition and information relating to other individual patient's success or treatments that may be beneficial for any particular individual using the system 1 to manage a chronic medical condition. The login field may utilize an authentification process to allow any individual user located at a remote individual user computer 5 to log into the system 1 and access the database 11 and the computer processing portion. The login ID may be any alpha, numeric or alphanumeric sequence and may furthermore be selected by the user or assigned by the system 1. The Password field may contain any alpha, numeric or alphanumeric sequence that a user must input to verify their identity upon attempting to access database 11. If desired, a user may provide their login ID and password to an online medical provider such that the provider may monitor their medical input information. Address field preferably contains an address of the user but may contain any other contact information such as a post office box number, a work address, a telephone number, or an e-mail address where the user may be reached.

The online medical provider field may have information relating to the provider, their specialty and information that the provider may help with. The date/time field may contain a date and or a time that a user has submitted health statistics and information. Thus, a history for the user may be generated based on each submission the user provides. The date/time field may then be used to monitor the long term management of a chronic medical condition.

Other types of information may be utilized by the system to help the management of the chronic medical condition, including age information, weight information, exercise information, gender information, race information, family history information, medical history information and the like. Any number of other fields and input information may be utilized by the system to help in the management of a chronic medical condition, which will be apparent to one of ordinary skill in the art.

Additional embodiments may be used separately or in conjunction with the invention as described above. In particular, it is contemplated that the present invention may be utilized to monitor specific health conditions. For example, in an exemplary embodiment, the monitoring and treatment of diabetes may be undertaken. Individual information regarding patient treatment for diabetes may be input by the patient such as caloric intake, exercise, age, health history, and other medically relevant fields. The statistics for each individual patient may be stored and compiled against other patients having similar chronic diseases such as diabetes. Population statistics may be compiled from individual statistics and statuses. Each individual patient may be monitored from the information input and tips and educational information to help monitor and treat the chronic disease may be introduced to each individual patient on an as needed basis.

Further, the system 1 may utilize an advertising access 17 which may charge an advertiser fees to promote certain items that might be helpful in treatment of a chronic health issue. Individual user's privacy may be maintained by blocking access by certain parties to stored patient identifying information. Access to the database 11 may be accomplished via the Internet, direct modem access, and the like. Other variations of the instant invention may also be apparent to one of ordinary skill in the art.

It is contemplated that individual patient information would be input by the individual patients from their individual user computer 5. Each individual patient could be directed to input information into the system 1, whereby the health information may be processed by the processing portion 15 and stored in the database 11, where the individual user record would be created and the relevant changes in long term user information may be stored. The processing portion 15 may also contain authentication information for each online medical provider/counselor 16 and the individual user utilizing an individual user computer 5 from a remote location.

Each individual user may be directed to a specific disease management area within the system to allow them to access their information, health statistics and other tools that may be utilized by the individual patient to manage chronic health care issues. This long term access would allow the individuals to track their chronic disease over a period of time, allowing them to see improvements or digressions in their medical conditions. The long term access would also allow the individual patient to have treatment options given to them based on medical records and input health statistics.

Once information has been inputted into the system, the individuals may be directed to an area which allows them to learn information relating to their specific medical condition. The system and program may deliver to an individual with a specific medical condition, comprehensive disease management programs that are centered on behavior modification and education about the disease and the long and short term impact on their lives. The education program may provide the user a day-by-day management program which lasts for a predetermined period of time.

Although the invention has been described in detail in the foregoing embodiments, it is to be understood that they have been provided for purposes of illustration only and that other variations both in form and detail can be made thereupon by those skilled in the art without departing from the spirit and scope of the invention, which is defined solely by the appended claims.

1. An online medical education system, the system comprising:
an online website having a plurality of sub-sites;
an input criterion page whereby an end user inputs specific information into the criterion page;
a remote central server having a database for collection of input criterion;
a processing portion for analyzing and providing medically relevant information to the end user based on user input criterion; and
a targeted interactive personal engagement portion.

2. The system described in claim 1 wherein said targeted interactive personal engagement portion provide instructions relating to specific chronic diseases.

3. The system described in claim 1 wherein said system provides educational information to end user for a chronic disease.

4. The system described in claim 3 wherein said chronic disease is diabetes.

5. The system described in claim 1 wherein said system provides a targeted educational steps and reminders to users.

6. The system described in claim 1 wherein said system provides an online social networking portion to allow users to interact with other users with the same chronic health condition.

7. The system described in claim 1 wherein said system utilizes questionnaires, surveys, medical files and other target information to allow the user to manage and illustrate progress of disease management.

8. The system described in claim 1 wherein the system provides direct marketing and advertising to an end user.

9. The system described in claim 1 wherein the system incentivizes users to engage in online activities with virtual and non-virtual incentives.

10. The system described in claim 1 wherein the system identifies patient candidates for clinical, qualitative and quantitative research.

11. A method of providing online medical education, the method comprising the steps of:
having a remote individual user computer to access an online website;
providing a remote central server having a database for collection of input criterion;
providing a processing portion for analyzing and providing medically relevant information to the end user based on user input criterion; and
providing a feedback module to transmit medical information relating to care of a chronic medical condition to the individual user computer.

12. The method of claim 11 further comprising the step of:
providing educational information to end user for a chronic disease.

13. The method of claim 11 further comprising the step of:
Providing research access from a remote location for inclusion of the most recent research information to the individual end user computer.

14. The method of claim 11 further comprising the step of:
providing an online social networking portion to allow users to interact with other users with the same chronic health condition.

15. The method of claim 11 further comprising the step of:
providing direct marketing and advertising to an end user.
